(19) United States
(12) Patent Application Publication
(10) Pub. No.: US 2013/0200840 A1
(43) Pub. Date: Aug. 8, 2013

(54) BATTERY MANAGING SYSTEM AND METHOD

(71) Applicants: HONG FU JIN PRECISION INDUSTRY(ShenZhen), Shenzhen City (CN); HON HAI PRECISION INDUSTRY CO., LTD., Tu-Cheng (TW)

(72) Inventor: LIANG CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/626,985

(22) Filed: Sep. 26, 2012

(30) Foreign Application Priority Data
Feb. 7, 2012 (CN) 201210025992.4

(51) Int. Cl. H02J 7/00

(52) U.S. Cl. 320/107; 320/134

(57) ABSTRACT

A battery managing system includes a charging module and a control module. The charging module is connected to a battery. The control module includes a main control unit and a battery monitoring unit. The battery monitor unit monitors a quantity of the electrical charge remained in battery. The main control unit prohibits the charging module charging the battery when the quantity of the electrical charge remained in the battery is less than a threshold value.

### BACKGROUND

1. Technical Field

The present disclosure relates to a battery managing system and method.

2. Description of Related Art

Portable electronic devices, such as cellular phones, laptop computers, and tablet computers, have become widespread. Accordingly, it has become necessary to include a battery to provide power to the electronic devices. However, when a battery is charged and discharged frequently, the battery often has a short life.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a battery managing system according to an embodiment.

FIG. 2 is another block diagram of the battery managing system of FIG. 1.

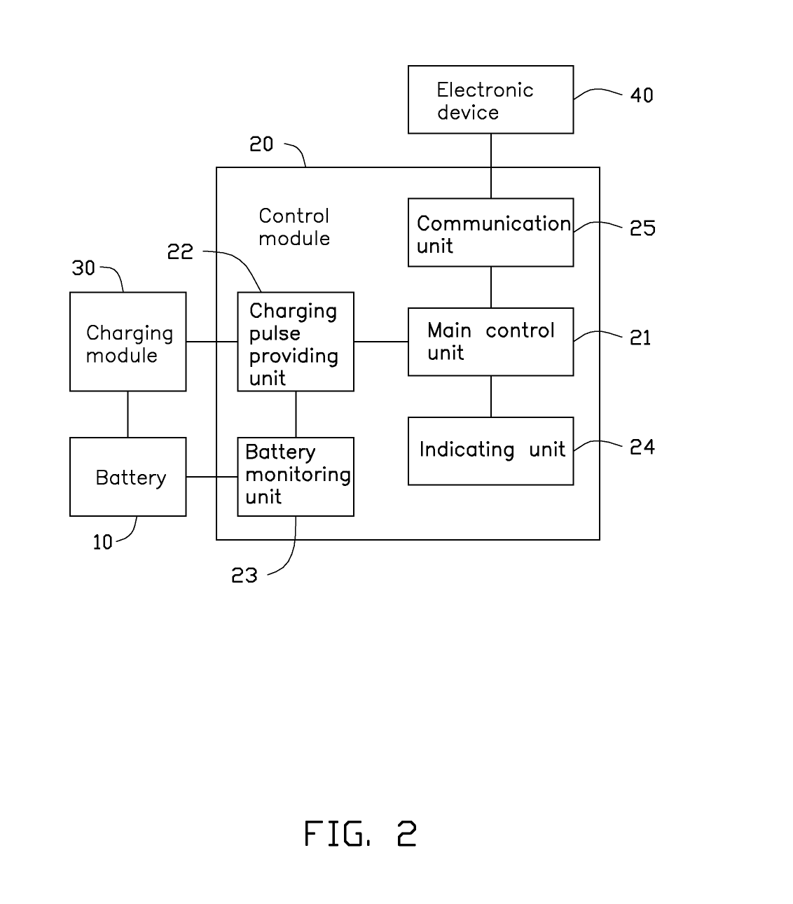

FIG. 3 is a flow chart of a battery managing method according to an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

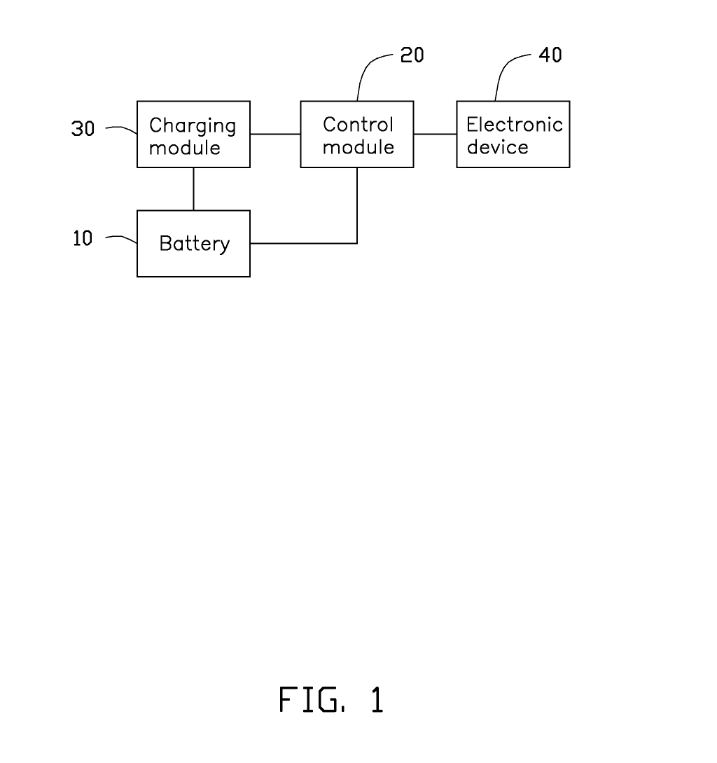

FIG. 1 shows a battery managing system according to an embodiment includes a control module 20, a charging module 30 and an electronic device 40. The battery managing system is used to manage a battery 10, which is mounted in the electronic device 40. The battery 10 is connected to the control module 20. The control module 20 is connected to the electronic device 40. The battery 10 supplies power for the electronic device 40.

FIG. 1 shows details of the control module 20. The control module 20 includes a main control unit 21, a charging pulse providing unit 22, a battery monitoring unit 23, an indicating unit 24, and a communication unit 25. The main control unit 21 is connected to the charging pulse providing unit 22, the battery monitoring unit 23, the indicating unit 24, and the communication unit 25.

The charging pulse providing unit 22 is connected to the charging module 30.

The charging pulse providing unit 22 can provide different charging pulses, which have different pulse widths, to the charging module 30 to charge the battery 10. When the pulse width is large, the charging module 30 charges the battery 10 with a large charging voltage. When the pulse width is small, the charging module 30 charges the battery 10 in a small or trickle charging voltage.

The battery monitoring unit 23 is connected to the battery 10. The battery monitoring unit 23 monitors information of the battery 10 and transmits the information of the battery 10 to the main control unit 21. The information of the battery 10 includes a quantity of electrical charge remaining in the battery 10, a temperature of the battery 10, a voltage of the battery 10, and a current of the battery 10.

The indicating unit 24 includes a plurality of indicating lights, which includes a red light, a yellow light, and a green light. The main control unit 21 controls the plurality of lights to indicate the information of the battery 10.

The communication unit 25 is connected to the electronic device 40 for communicating between the main control unit 21 and the electronic device 40.

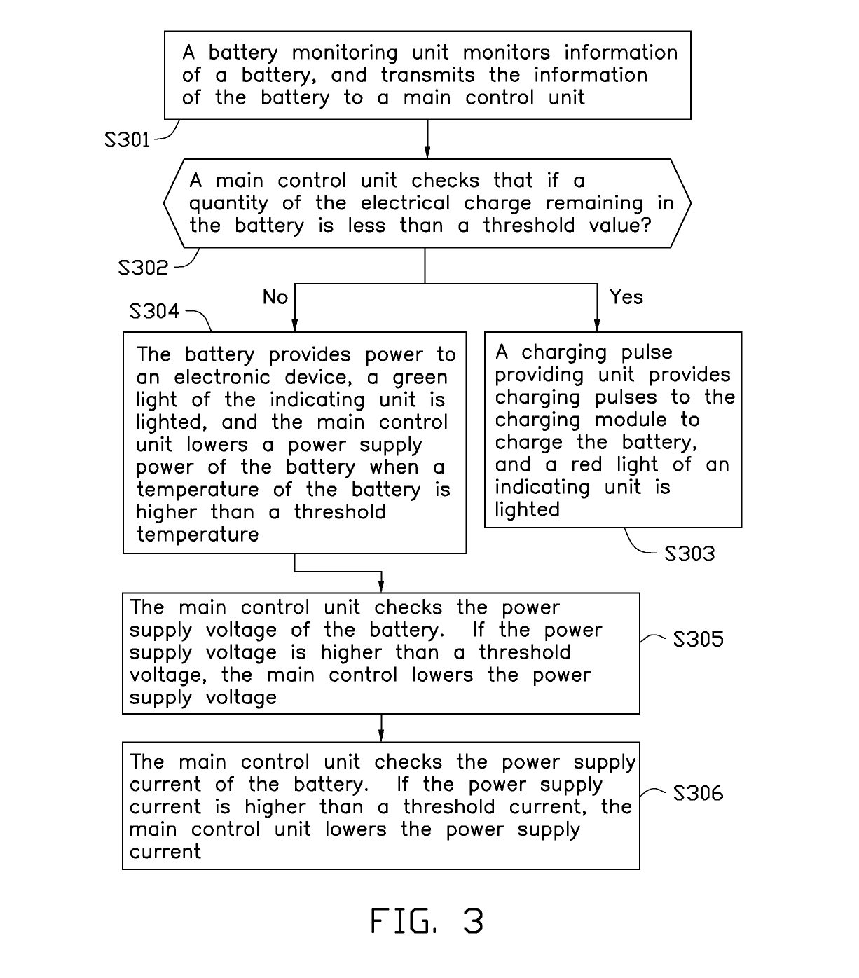

FIG. 3 shows an embodiment of a flow chart of a battery management method for a battery, which includes following steps:

In step S301, the battery monitoring unit 23 monitors information of the battery 10, and transmits the information of the battery 10 to the main control unit 21. The information of the battery 10 includes the quantity of the electrical charge remained in the battery 10, the temperature of the battery 10, the power supply voltage of the battery 10, and the power supply current of the battery 10.

In step S302, the main control unit 21 checks that if the quantity of the electrical charge remained in the battery 10 is less than a threshold value (such as 15000 mAh). If yes, go to step S303; and if no, go to step S304.

In step S303, the charging pulse providing unit 22 provides charging pulses to the charging module 30 to charge the battery 10, and the red light of the indicating unit 24 is turned on. A width of the charging pulses is controlled by the charging pulse providing unit 22. For example, if the battery 10 needs to be charged quickly, the charging pulse providing unit 22 increases the duty cycles or width of the charging pulses; and if the battery 10 does not need to be charged quickly, the charging pulses providing unit 22 decreases the duty cycles or width of the charging pulses.

In step S304, the battery 10 provides power to the electronic device 40, the green light of the indicating unit 24 is on, and the main control unit 21 monitors the temperature of the battery 10. If the temperature of the battery 10 is higher than a threshold temperature (such as 40 degrees Centigrade) then the main control unit 21 lowers a charging power to the battery 10, and the yellow light of the indicating unit 24 is lit.

In step S305, the main control unit 21 checks the power supply voltage of the battery 10. If the power supply voltage is higher than a threshold voltage (such as 20 volt), the main control unit 21 lowers the power supply voltage of the battery 10, and the yellow light of the indicating unit 24 is lighted.

In step S306, the main control unit 21 checks if the power supply current of the battery 10 is higher than a threshold current (such as 2 ampere). If yes, the main control unit 21 lowers the power supply current of the battery 10, and the yellow light of the indicating unit 24 is lighted.

According to the battery managing system and method, the battery 10 is only charged when the quantity of the electrical charge remained in the battery 10 is low, and the main control unit 21 controls the power supply power, the power supply voltage, and the power supply current of the battery on time. Therefore, a life of the battery 10 is extended.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A battery managing system, comprising:
a charging module connected to a battery; and
a control module comprising a main control unit and a battery monitoring unit, the battery monitor unit being configured to monitor a quantity of the electrical charge remained in the battery, and the main control unit being configured to prohibit the charging module charging the battery when the quantity of the electrical charge remained in the battery is less than a threshold value.

2. The battery managing system of claim 1, wherein the control module further comprises a charging pulse providing unit, the charging pulse providing unit is connected to the charging module, the charging pulse providing unit is configured to provide charging pulses to the charging module to charge the battery.

3. The battery managing system of claim 2, wherein the charging module is configured to charge the battery quicker when a width of the charging pulses is larger.

4. The battery managing system of claim 1, wherein the battery monitor unit is configured to monitor a temperature of the battery, and the main control unit is configured to lower a power supply power of the battery when the temperature of the battery is higher than a threshold temperature.

5. The battery managing system of claim 1, wherein the battery monitor unit is configured to monitor a power supply voltage of the battery, and the main control unit is configured to lower the power supply voltage of the battery when the power supply voltage is higher than a threshold voltage.

6. The battery managing system of claim 1, wherein the battery monitor unit is configured to monitor a power supply current of the battery, and the main control unit is configured to lower the power supply current of the battery when the power supply current is higher than a current voltage.

7. The battery managing system of claim 1, the control module further comprising an indicating unit, wherein the indicating unit is configured to indicate different states of the battery.

8. A battery managing method, comprising:
monitoring information of a battery by a battery monitoring unit, wherein the information of the battery comprises a quantity of the electrical charge remained in the battery, a temperature of the battery, a power supply voltage of the battery, and a power supply current of the battery;
charging the battery by a charging module when the quantity of the electrical charge remained in the battery is lower then a threshold value, and the battery providing power when the quantity of the electrical charge remained in the battery is equal to or higher than the threshold value; and
lowering a power supply power of the battery when the temperature of the battery providing power is higher than a threshold temperature.

9. The battery managing method of claim 8, further comprising lowering a power supply voltage of the battery when the power supply voltage is higher than a threshold voltage.

10. The battery managing method of claim 8, further comprising lowering a power supply current of the battery when the power supply current is higher than a threshold current.

11. The battery managing method of claim 8, further comprising indicating different states of the battery by an indicating module.

12. The battery managing method of claim 8, further comprising providing charging pulses to the charging module when the charging module charges the battery.

13. The battery managing method of claim 12, wherein the charging module is configured to charge the battery quicker when a width of the charging pulses is larger.
